(19) United States
(12) Patent Application Publication
(10) Pub. No.: US 2005/0284763 A1
(43) Pub. Date: Dec. 29, 2005

(54) Integrative microdialysis and chip-based electrophoresis system with online labeling function and analytical method using same

(75) Inventors: Shu-Hui Chen, Tainan City (TW); Hsuan-Hsiu Hsu, Taipei City (TW); Yi Hsuan Hu, Bade City (TW); Chun-Che Lin, Yongkang City (TW)

Correspondence Address: BACON & THOMAS, PLLC, 625 SLATERS LANE, FOURTH FLOOR, ALEXANDRIA, VA, 22314, US

(73) Assignee: National Cheng Kung University, Tainan City (TW)

(21) Appl. No.: 11/167,148

(22) Filed: Jun. 28, 2005

(30) Foreign Application Priority Data
Jun. 29, 2004 (TW) 93119014

(51) Int. Cl. B01D 57/02; G01N 27/453

(52) U.S. Cl. 204/451; 204/601

(57) ABSTRACT

An integrative microdialysis and chip-based electrophoresis system and analytical method using the same are disclosed. The system combines the microdialysis probe sampling technique and continuous pressure flow feeding coupled with chip-based electrophoresis analysis. It is capable of performing online sampling as well as rapid and continuous monitoring and analysis of biological samples. The system offers the advantages of real-time on-chip dye labeling, simple apparatus setup and easy operation.

### BACKGROUND OF THE INVENTION

1. Field of the Invention

The present invention discloses an integrative microdialysis and chip-based electrophoresis analytical system with online labeling function and analytical method using the same that may be applied in the fields of drug delivery, pharmacokinetics, neurotransmission and food science.

2. Description of Related Art

Biochips are not clearly defined or categorized. It typically refers to precise, miniaturized device using silicon chip, glass or polymer as substrate and integrating micro technologies in the fields of mechanico-electrical (MEMS), opto-electrical, chemistry, biochemistry, medical engineering and molecular biology. Biochips may be used in medical testing, environmental testing, food testing, new drug development, basic research, military defense, and chemical synthesis. Biochips are classed into gene chip, protein chip, and lab-on-a-chip on the market. Lab-on-a-chip is designed according to needs where different reactions take place on a microchip. Currently biochemical reactions that may be carried on lab-on-a-chip include polymerase chain reaction (PCR) with gene amplification function, nucleic acid sequencing reaction, microfluidics, electrophoresis, mass spectrography, antigen-antibody binding, and regular enzymatic reaction.

Microfluidic chip for biomedical testing fabricated by MEMS process offers the advantages of high performance, low sample consumption, low energy consumption, small size, and low cost. The design that integrates microfluidic system and testing mechanism on the same chip presents the greatest development potential and market value, for one single chip of miniaturized size can offer the complete testing functions without the use of sophisticated and expensive equipment. Microdialysis is similar to the working of capillaries that entails infusing and perfusing isotonic solution at constant speed through a probe with membrane. The same probe can deliver or extract chemical substances of smaller molecular weight in tissues, such as amino acid and peptide. The microdialysis technique is now widely applied in the real-time in-vivo sampling and monitoring. For separation of amino acids, microdialysis technique is primarily coupled with capillary electrophoresis or high-performance liquid chromatography (HPLC). Such approach not only requires sophisticated apparatus, it typically performs off-line collection and analysis, hence consuming more samples and unable to obtain high observation of temporal resolution. If online analysis is carried out, the large retention volume at the interface between systems makes real-time monitoring difficult, resulting in over-extended time span to obtain temporal resolution. When such approach applies to sample study requiring high temporal resolution, real-time detection of signal variation is impossible, which becomes a big limitation on the research of analyte with rapidly changing concentration. On the other hand, it is a big challenge to completely separate two important neurotransmitters—glutamate and aspartate that differ only by one methyl group by a channel shorter than 5 cm of a microchip.

### SUMMARY OF THE INVENTION

To address the drawback of prior art, the present invention aims to provide an integrative microdialaysis and chip-based electrophoresis system and analytical method using the same that allows real-time feeding and separation of analyte and detection of its concentration change. This system offers shortened feeding, separation and detection time. It is able to detect rapid concentration change of sample, hence suitable for analysis of samples with high temporal resolution and applicable to continuous monitoring of the reactions of live animals.

The object of the present invention is to provide an integrative microdialaysis and chip-based electrophoresis system comprising: a microdialysis probe for extracting the sample; a feeding apparatus to provide the motive force for sample feeding; an electrophoretic chip for online labeling and electrophoretic separation of sample; a power supply to supply a voltage to the electrophoretic chip for it to carry out online labeling and electrophoretic separation of sample; and a detection unit to detect signals generated by the labeled and electrophoretically separated sample.

Said microdialysis probe contains an inner tube and an outer tube; the inner tube connects to the feeding apparatus and the outer tube connects to the electrophoretic chip.

Said feeding apparatus may be a pump, for example, a syringe pump.

Said detection unit may be further coupled with a photomultiplier tube (PMT) to amplify signals.

Another object of the present invention is to provide a chip-based electrophoresis device with online labeling function, comprising an electrophoretic chip for online labeling and electrophoretic separation of sample; and a power supply to provide voltage to said electrophoretic chip, where the electrophoretic chip contains a top plate having a plurality of holes thereon, and a bottom plate having a sample separation cell and a sample labeling cell thereon. The plurality of holes on the top plate include a feed hole, a waste fluid drain hole, an analyte drain hole, and a labeling reagent storage hole. The sample separation cell of the bottom plate is cross-connected with the sample labeling cell. When the top plate and the bottom plate are adjoined together, the feed hole and analyte drain hole on the top plate are respectively disposed at opposites sides of sample separation cell of bottom plate, whereas the waste fluid drain hole and labeling reagent storage hole are disposed at opposite sides of sample labeling cell, and the sample separation cell and sample labeling cell form a channel inside the chip.

The term “labeling” means reacting the analyte with a labeling reagent to derivatize the analyte. Labeling helps enhance the sensitivity and specificity of detection. Labeling reagent includes but is not limited to dye and isotope reagent.

Yet another object of the present invention is to provide an analytical method using the integrative microdialaysis and chip-based electrophoresis system, comprising the steps of: (a) providing a sample; (b) placing the microdialysis probe in the sample; (c) introducing sample extracted by the microdialysis probe into the electrophoretic chip; (d) labeling and separating the sample online; and (e) detecting signal changes.

In step (c) above, buffer is fed fluidically into the inner tube of microdialysis probe by feeding apparatus and perfused into the chip channel through the outer tube of probe.

In step (d) of online labeling and separation above, a power supply is employed to provide a voltage to control the movement of sample inside the chip. When the supplied voltage is regulated from feeding voltage to suppression voltage, the sample that undergoes online labeling in the chip channel would enter the sample separation cell to undergo separation.

### BRIEF DESCRIPTION OF THE DRAWINGS

FIG. 1 shows the schematic diagram of the integrative microdialysis and chip-based electrophoresis system according to the present invention.

FIG. 2 is a diagram of chip-based electrophoresis device with online labeling function according to the present invention.

FIG. 3A is a structural diagram of the top plate of electrophoretic chip according to the present invention.

FIG. 3B is a structural diagram of the bottom plate of electrophoretic chip according to the present invention.

FIGS. 4A, 4B and 4C are flow processes showing online labeling and separation of sample using the chip-based electrophoretic device according to the present invention.

FIG. 5 shows the result of glutamate (Glu) and aspartate (Asp) separation (Glu/Asp=4/1) using the integrative microdialysis and chip-based electrophoresis system according to the present invention.

FIG. 6 shows the result of glutamate (Glu) and aspartate (Asp) separation (Glu/Asp=1/4) using the integrative microdialysis and chip-based electrophoresis system according to the present invention.

### DETAILED DESCRIPTION OF THE INVENTION

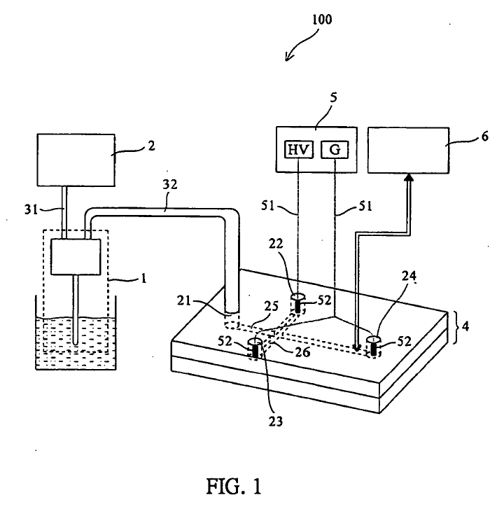

The integrative microdialaysis and chip-based electrophoresis system 100 disclosed by the invention as shown in FIG. 1 comprises: a microdialysis probe 1 for extracting the sample; a feeding apparatus 2 to provide the motive force for sample feeding; an electrophoretic chip 4 for online labeling and electrophoretic separation of sample; a power supply 5 to provide a voltage to the electrophoretic chip 4 for it to carry out online labeling and electrophoretic separation of sample; and a detection unit 6 to detect signals generated by the labeled and electrophoretically separated sample.

The microdialysis probe 1 contains an inner tube 31 and an outer tube 32; the inner tube 31 connects to the feeding apparatus and the outer tube 32 is used to collect sample outside the microdialysis probe into it through perfusion and introduce the sample into electrophoretic chip 4 for subsequent analysis.

The feeding apparatus 2 is a pump (e.g. syringe pump) to transport buffer solution into microdialysis probe 1 through inner tube 31. When the microdialysis system takes sample, the microdialysis probe 1 is placed in the sample to be analyzed where the analyte inside the sample perfuses into the outer tube 32 of microdialysis probe 1 and is carried by the buffer solution into the outer tube 32 before being injected into electrophoretic chip 4.

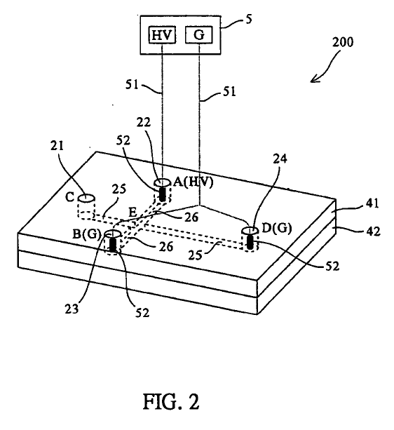

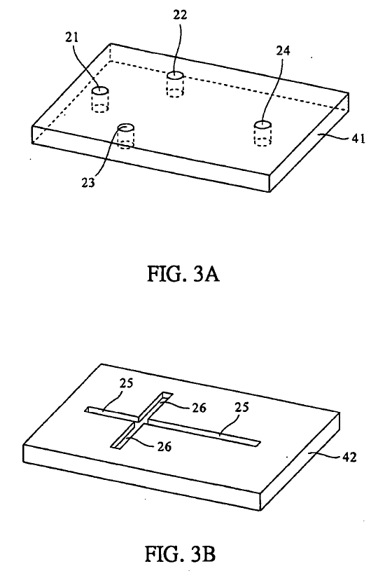

The chip-based electrophoresis device 200 with on-line labeling function as shown in FIG. 2 is made of a top plate 41, a bottom plate 42, and a power supply 5. As shown in FIG. 3A, top plate 41 is disposed with a plurality of through-holes, including a feed hole 21, waste fluid drain hole 23, analyte drain hole 24 and labeling reagent storage hole 22. The labeling reagent storage hole 22, waste fluid drain hole 23, and analyte drain hole 24 also have the function of electrode placement. Bottom plate 42, as shown in FIG. 3B, has cross-connected sample separation cell 25 and sample labeling cell 26. When the top plate 41 and the bottom plate 42 are adjoined together, the feed hole 21 and analyte drain hole 24 on the top plate are respectively disposed at opposite sides of sample separation cell 25, whereas labeling reagent storage hole 22 and waste fluid drain hole 23 are disposed at opposite sides of sample labeling cell 26. Labeling reagent storage hole 22, waste fluid drain hole 23, and analyte drain hole 24 have the function of a solution storage cell.

In order for the chip-based electrophoresis device 200 to perform its function, power supply 5 is connected to electrophoretic chip 4 as shown in FIG. 2 with the electrode wires 51 of power supply 5 connecting respectively to the electrodes 52 in labeling reagent storage hole 22, waste fluid drain hole 23, and analyte drain hole 24.

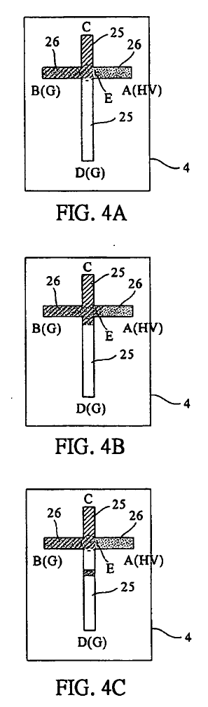

The operation of the integrative microdialaysis and chip-based electrophoresis system 100 according to the invention is described in detail below with accompanying drawings FIG. 1 and FIG. 4A-4C. When the sample is introduced continuously from the outer tube 32 of microdialysis probe 1 into electrophoretic chip 4 through feed hole 21 as shown in FIG. 4A (symbol “HV” means high voltage, symbol “G” means ground), the sample passes through the CE section of sample separation cell 25 to reach the intersection E of sample separation cell 25 and sample labeling cell 26. At the same time, labeling reagent in labeling reagent storage hole 22 would be subject to the suppression voltage from power supply 5 and moves from high voltage (HV) to low voltage (G) under electric field effect to enter the AE section of sample labeling cell 26 and arrive at intersection E. After the sample and the labeling reagent mix at intersection E, the sample in BE section that also passes the sample labeling cell 26 would reach waste fluid drain hole 23 under the action of electric field.

When the voltage applied by power supply 5 is in the state of zero as shown in FIG. 4B, the sample that passes through the CE section of sample separation cell 25 mixes with labeling reagent from AE section at intersection E. Because the field force of feeding voltage is zero, the mixture of labeling reagent and sample would split-flow into the AE, BE and DE sections of sample separation cell 25 and sample labeling cell 26 according to tube size. The holding time of feeding voltage will determine the respective volume of labeled sample into the AE, BE and DE sections.

When the voltage supplied by power supply 5 is regulated from feeding voltage to suppression voltage as shown in FIG. 4C, sample that passes through the CE section of sample separation cell 25 would mix with labeling reagent that passes through the AE section of sample labeling cell at intersection E. Under the electric field effect, the mixture would enter the BE section of sample labeling cell 26 to reach waste fluid drain hole 23. The sample that enters the DE section of sample separation cell 25 as shown in FIG. 4C begins separation under the actions of separation solvent filled in the DE section and electrophoresis. The separated sample can be detected and read by detection unit 6.

The advantages of the present invention are further depicted with the illustration of examples, but the descriptions made in the examples should not be construed as a limitation on the actual application of the present invention.

### EXAMPLE 1

In this example, the integrative microdialaysis and chip-based electrophoresis system with online labeling function 100 is applied to the separation of glutamate and aspartate. Glutamate and aspartate are important neurotransmitters that differ only by one methyl group, making their separation a significant challenge. The separation steps with accompany drawing FIG. 1 are described below: first prepare a mixture of 20 mM glutamate and 5 mM aspartate; put 0.5 ml of mixture in an ependorf and place the microdialysis probe in the tube. Microdialysis probes are usually stored in glycerol and must be cleaned before use. The cleaning process includes the following steps: soak the newly unpacked microdialysis probe in a solution containing 75% ethanol, next load the syringe pump (i.e. one embodiment of feeding apparatus 2) with DI water and hook the pump to the probe to push DI water through the probe continuously for 20 minutes at the flow rate of 2 μl/min to remove surface glycerol; next place the microdialysis probe in DI water and wash the probe with DI water loaded in a syringe continuously for 30 minutes at the flow rate of 2 μl/min to complete the cleaning. After placing the cleaned microdialysis probe in the ependorf containing the glutamate/aspartate mixture, fill the syringe with 25 mM borate acid buffer and push continuously for 25 minutes at the flow rate of 2 μl/min to make sure both the inner and outer tubes of microdialysis probe are filled with buffer solution; rinse the channels inside the chip (sample separation cell 25 and sample labeling cell 26 in FIG. 1) with water for 10 minutes, followed by NaOH for 10 minutes and then water again for 10 minutes. Next fill the channels with 25 mM borate buffer solution containing 15 mM surfactant and 3 mM β-cyclodextrin, and take respectively 100 μl solution to inject into the solution storage cells formed by waste fluid drain hole 23 and analyte drain hole 24. Next add 120 mM ortho-phthalaldehyde (OPA) as labeling reagent into the solution storage cell formed by labeling reagent storage hole 22. After making sure the feed hole 21 of chip and outer tube of microdialysis probe 32 are filled with buffer solution and free of air bubbles, insert the outer tube of microdialysis probe into feed hole 21. Confirm again the absence of air bubble to complete the apparatus setup.

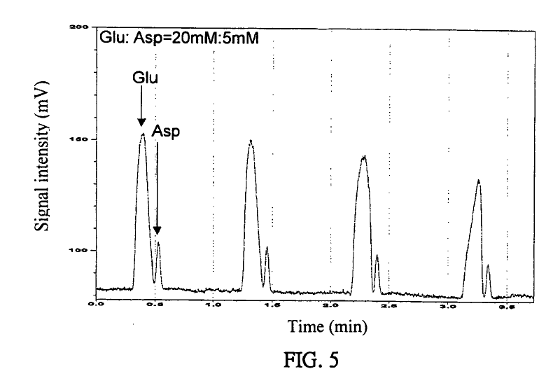

After the apparatus is set up, continue to inject buffer solution at the flow rate of 0.1 μl/min with syringe. Set the suppression voltage at 3.0 kV, feeding voltage of sample injection at 0 V, and feeding time of 3 sec. The detection unit 6 is a laser-induced fluorophor (LIF) with the voltage of its photomultiplier tube (PMT) set at −600 V. The detected signals are transformed and amplified by PMT. The process for online labeling and separation of sample is as illustrated in FIG. 4A-4C. As shown in FIG. 5, the integrative microdialaysis and chip-based electrophoresis system with online labeling function 100 according to the invention can rapidly label glutamate and aspartate and separate the two substances online, and changes in signal intensity of the two analytes are directly proportional to changes in their concentration.

### EXAMPLE 2

In this example, an experiment of concentration comparison is carried out following the same steps as in Example 1. Prior to the experiment, remove the microdialysis probe from the sample solution in Example 1 and place it in plastic ependorf filled with DI water and wash the probe continuously for 30 minutes at the flow rate of 2 μl/min to complete probe cleaning.

Prepare a mixture of 5 mM glutamate and 20 mM aspartate and put 0.5 mL of the mixture solution in a 0.5 mL plastic ependorf. Place the cleaned microdialysis probe in the ependorf. Fill the syringe with 25 mM borate acid buffer and push the syringe continuously for 25 minutes at the flow rate of 2 μl/min to make sure both the inner and outer tubes of microdialysis probe are filled with buffer solution; rinse the channels inside the chip (sample separation cell 25 and sample labeling cell 26 in FIG. 1) with water for 10 minutes, followed by NaOH for 10 minutes and then water again for 10 minutes. Next fill the channels with 25 mM borate buffer solution containing 15 mM surfactant and 3 mM β-cyclodextrin, and take respectively 100 μl solution to inject into the solution storage cells formed by waste fluid drain hole 23 and analyte drain hole 24. Next add 120 mM ortho-phthalaldehyde (OPA) as labeling reagent into the solution storage cell formed by labeling reagent storage hole 22. After making sure the feed hole 21 of chip and outer tube of microdialysis probe 32 are filled with buffer solution and free of air bubbles, insert the outer tube of microdialysis probe into feed hole 21. Confirm again the absence of air bubble to complete the apparatus setup.

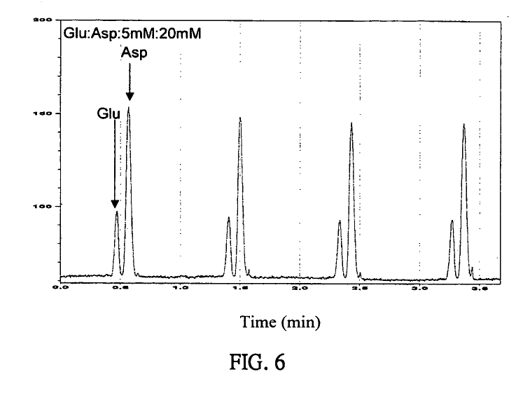

After the apparatus is set up, continue to inject buffer solution at the flow rate of 0.1 μl/min with syringe. Set the suppression voltage at 3.0 kV, feeding voltage of sample injection at 0 V, and feeding time of 3 sec. The detection unit 6 is a laser-induced fluorophor (LIF) with the voltage of its photomultiplier tube (PMT) set at −600 V. The detected signals are transformed and magnified by PMT. The process for online labeling and separation of sample is as illustrated in FIG. 4A-4C. As shown in FIG. 6, rapid online labeling and separation can be achieved, and changes in signal intensity of the two analytes are directly proportional to changes in their concentration. By comparing the results obtained in this experiment to FIG. 5, it is learned that the analyte with shorter migration time is glutamate and that with longer migration time is aspartate, and the separation efficiency is not affected by the concentration of reactants.

As described above, the integrative microdialaysis and chip-based electrophoresis system with online labeling function of the invention features simple setup and easy operation. The system couples the microfluidic chip with microdialysis technique and requires only small amount of sample for analysis. It also features rapid feeding, separation and detection. Online labeling inside the chip further accelerates the detection speed to facilitate the detection of analyte concentration in vivo.

### Other Embodiments

The embodiments of the present invention have been described in detailed in the examples. All modifications and alterations made by those familiar with the skill without departing from the spirits of the invention shall remain within the protected scope and claims of the invention.

What is claimed is:

1. An integrative microdialysis and chip-based electrophoresis system, comprising:
a microdialysis probe for extracting a sample;
a feeding apparatus to provide motive force for feeding the sample;
an electrophoretic chip for online labeling and electrophoretic separation of the sample;
a power supply to provide a voltage to said chip-based electrophoresis device for it to carry out online labeling and electrophoretic separation of the sample; and
a detection unit to detect signals generated by the sample after online labeling and electrophoretic separation.

2. The system according to claim 1, wherein the microdialysis probe comprises an inner tube and an outer tube.

3. The system according to claim 2, wherein the inner tube connects to the feeding apparatus and the outer tube connects to the electrophoretic chip.

4. The system according to claim 1, wherein the feeding apparatus is used to feed buffer solution into the inner tube of microdialysis tube.

5. The system according to claim 1, wherein the feeding apparatus is a pump.

6. The system according to claim 5, wherein the pump is a syringe pump.

7. The system according to claim 1, wherein the detection unit further couples with a photomultiplier tube to amplify the signals.

8. A chip-based electrophoresis device with online labeling function, comprising:
an electrophoretic chip for labeling and separating a sample; and
a power supply to provide a voltage for separating the sample to be analyzed.

9. The chip-based electrophoresis device according to claim 8, wherein the electrophoretic chip contains a top plate having a plurality of holes thereon; and a bottom plate having a sample separation cell and a sample labeling cell thereon.

10. The chip-based electrophoresis device according to claim 9, wherein the plurality of holes on top plate include a feed hole, a waste fluid drain hole, an analyte drain hole, and a labeling reagent storage hole.

11. The chip-based electrophoresis device according to claim 9, wherein the sample separation cell and sample labeling cell are cross connected.

12. The chip-based electrophoresis device according to claim 10, wherein the feed hole is for the feeding of sample.

13. The chip-based electrophoresis device according to claim 10, wherein the labeling reagent storage hole is to store labeling reagent.

14. The chip-based electrophoresis device according to claim 8, wherein the power supply connects to the waste fluid drain hole, analyte drain hole and labeling reagent storage hole of chip by electrode wires and electrodes.

15. An analytical method using the integrative microdialysis and chip-based electrophoresis system according to claim 1, comprising the steps of:
(a) providing a sample;
(b) placing the microdialysis probe in the sample;
(c) feeding the sample extracted by the microdialysis probe into the electrophoretic chip;
(d) carrying out online labeling and separation of the sample; and
(e) detecting changes in signal.

16. The analytical method according to claim 15, wherein in step (c), feeding apparatus feeds buffer solution by fluidic means into the inner tube of microdialysis tube, through which, sample outside the probe enters the outer tube of microdialysis probe by perfusion and then enters the electrophoretic chip.

17. The analytical method according to claim 15, wherein in step (d), power supply provides a voltage to control the movement of the sample inside the electrophoretic chip.
